(19) United States
(12) Patent Application Publication
(10) Pub. No.: US 2010/0143774 A1
(43) Pub. Date: Jun. 10, 2010

(54) RECHARGEABLE BATTERY AND ELECTRODE ASSEMBLY

(76) Inventors: Man-Seok Han, Suwon-si (KR); Eui-Hwan Song, Suwon-si (KR); Jin-Kyu Hong, Suwon-si (KR); Jun-Sik Kim, Suwon-si (KR); Yong-Chul Park, Suwon-si (KR); Kyeu-Yoon Sheem, Suwon-si (KR); Nam-Soon Choi, Suwon-si (KR); Tae-Keun Kim, Suwon-si (KR); Atsuo Omaru, Suwon-si (KR); Satoshi Narukawa, Suwon-si (KR)

Correspondence Address: CHRISTIE, PARKER & HALE, LLP, PO BOX 7068, PASADENA, CA, 91109-7068, US

(21) Appl. No.: 12/633,676

(22) Filed: Dec. 8, 2009

(30) Foreign Application Priority Data
Dec. 9, 2008 (KR) 10-2008-0124879

(51) Int. Cl. H01M 6/10; H01M 10/18

(52) U.S. Cl. 429/94; 429/210

(57) ABSTRACT

A rechargeable battery includes an electrode assembly that includes a positive electrode, a negative electrode, a first bipolar electrode between the negative electrode and the positive electrode, and a second bipolar electrode between an outer surface of the electrode assembly and the positive electrode or between a center of the electrode assembly and the negative electrode, wherein the positive electrode, the negative electrode, and the first and second bipolar electrodes are stacked and wound together, and a lead electrically coupled with the electrode assembly. The electrode assembly may include separators between the positive electrode, the negative electrode, and the first and second bipolar electrodes.

### CROSS-REFERENCE TO RELATED APPLICATION

This application claims priority to and the benefit of Korean Patent Application No. 10-2008-0124879 filed in the Korean Intellectual Property Office on Dec. 9, 2008, the entire disclosure of which is incorporated herein by reference.

### BACKGROUND OF THE INVENTION

1. Field of the Invention

The present invention relates to a rechargeable battery and an electrode assembly.

2. Description of the Related Art

Rechargeable batteries can be repeatedly charged and discharged, unlike primary batteries that cannot be repeatedly charged. A low-capacity rechargeable battery with one cell or few cells is used for small portable electronic devices, i.e., mobile phones, laptop computers, or camcorders. A large-capacity rechargeable battery with a plurality of cells connected to each other in a pack is widely used for a power supply for driving a motor in a hybrid electric vehicle.

Rechargeable batteries are manufactured in various shapes, including a cylindrical shape, a rectangular shape, etc.

Rechargeable batteries, which may be coupled with each other in series to be used for driving a motor in an electric vehicle, etc., which require high power, constitute a large-capacity rechargeable battery module.

Rechargeable batteries include an electrode assembly in which a positive electrode and a negative electrode are positioned with a separator therebetween, a case configured to receive the electrode assembly, and a cap assembly that seals the case.

In cylindrical-shaped rechargeable batteries, the positive electrode and the negative electrode of the electrode assembly include an uncoated region where an active material is not applied. Such a positive electrode uncoated region and a negative electrode uncoated region are located on opposite ends of the electrode assembly.

A negative electrode current collecting plate is attached to the negative electrode uncoated region and a positive electrode current collecting plate is attached to the positive electrode uncoated region. The negative electrode current collecting plate is electrically connected with the case and the positive electrode current collecting plate is electrically connected with the cap assembly to direct current to the outside. Accordingly, the case serves as a negative electrode terminal and a cap-up installed in the cap assembly serves as a positive electrode terminal.

In the rechargeable battery, it is very important to form a high-output and high-capacity rechargeable battery. However, the volume of the rechargeable battery must be increased to increase the output and capacity of the rechargeable battery, and it is difficult to properly control the output and capacity thereof.

### SUMMARY OF THE INVENTION

A rechargeable battery and an electrode assembly that increases battery output is provided.

An embodiment according to the present invention provides an electrode assembly that includes a positive electrode including a positive electrode current collector and a positive active material layer, a negative electrode including a negative electrode current collector and a negative active material layer, a first bipolar electrode between the positive electrode and the negative electrode, and a second bipolar electrode between an outer surface of the electrode assembly and the positive electrode or between a center of the electrode assembly and the negative electrode, and separators between the positive electrode, the negative electrode, and the first and second bipolar electrodes.

Each of the first and second bipolar electrodes may include a current collector, a first active material layer on one surface of the current collector and including a positive active material, and a second active material layer on the other surface of the current collector and including a negative active material.

The first active material layer may include lithium transition metal composite oxide and the second active material layer may include a material selected from the group consisting of lithium transition metal composite oxide, graphite, carbon, and combinations thereof.

Each of the first and second bipolar electrodes may include two bipolar electrodes.

The positive electrode may include a positive electrode uncoated region and a positive electrode coated region, the positive electrode coated region including the positive active material layer.

The negative electrode may include a negative electrode uncoated region and a negative electrode coated region, the negative electrode coated region including the negative active material layer.

The positive electrode uncoated region may be located at one longitudinal end of the electrode assembly and the negative electrode uncoated region may be located at the other longitudinal end of the electrode assembly.

The positive electrode, the negative electrode, and the first and second bipolar electrodes may be stacked and wound in a cylindrical shape.

Another embodiment according to the present invention provides a rechargeable battery that includes an electrode assembly including a positive electrode, a negative electrode, and a first bipolar electrode between the negative electrode and the positive electrode and a second bipolar electrode between an outer surface of the electrode assembly and the positive electrode or between a center of the electrode assembly and the negative electrode, wherein the positive electrode, the negative electrode, and the first and second bipolar electrodes are stacked and wound together, and a lead electrically coupled with the electrode assembly.

The rechargeable battery may further include separators between the positive electrode, the negative electrode, and the first and second bipolar electrodes.

Each of the first and second bipolar electrodes may include a current collector, a first active material layer on one surface of the current collector and including a positive active material, and a second active material layer on the other surface of the current collector and including a negative active material.

Each of the first and second bipolar electrodes may include two bipolar electrodes.

The positive electrode may include a positive electrode uncoated region and a positive electrode coated region including the positive active material layer.

The negative electrode may include a negative electrode uncoated region in and a negative electrode coated region, including the negative active material layer.

The positive electrode uncoated region may be located at one longitudinal end of the electrode assembly and the negative electrode uncoated region may be located at the other longitudinal end of the electrode assembly.

The rechargeable battery may further include a front sealing unit formed by applying a sealing agent at an end positioned at an innermost portion of the electrode assembly.

The rechargeable battery may further include a side sealing unit formed by applying a sealing agent at ends of the positive electrode, the negative electrode, and the first and second bipolar electrodes located at or near the outer surface of the electrode assembly

The rechargeable battery may further include a lower sealing unit formed by applying a sealing agent on a bottom end of the electrode assembly

The rechargeable battery may further include an upper sealing unit formed by applying a sealing agent on an upper end of the electrode assembly.

The sealing agent may include a material selected from the group consisting of polyimide-based resins, polyethylene resins, polypropylene resins, and combinations thereof.

The rechargeable battery may further include a case containing the electrode assembly, and a cap assembly coupled with the case and electrically coupled with the electrode assembly.

### BRIEF DESCRIPTION OF THE DRAWINGS

FIG. 1 is a simplified schematic cross-sectional view of an electrode assembly according to a first exemplary embodiment of the present invention.

FIGS. 2 to 7 are schematic diagrams illustrating a process of manufacturing a rechargeable battery according to a first exemplary embodiment of the present invention.

FIG. 8 is a cross-sectional perspective schematic diagram of a rechargeable battery according to a second exemplary embodiment of the present invention.

FIG. 9 is a cross-sectional perspective schematic diagram of an electrode assembly according to a second exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

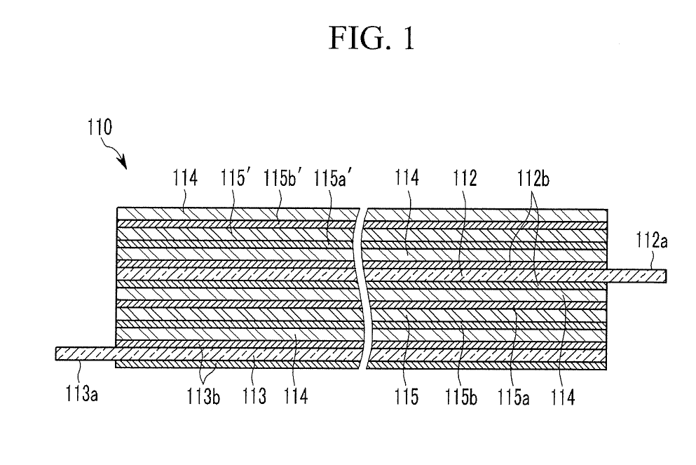

FIG. 1 is a simplified schematic cross-sectional diagram of an electrode assembly according to a first exemplary embodiment of the present invention.

Referring to FIG. 1, an electrode assembly 110 includes a positive electrode 112, a negative electrode 113, bipolar electrodes 115, 115′, and separators 114 therebetween.

The positive electrode 112 includes a positive electrode current collector 112a and a positive active material layer 112b. The positive electrode current collector 112a has a plate shape, which is made of aluminum, stainless steel, etc. The positive active material layer 112b is made of LiCoO₂, LiMnO₂, LiFePO₄, LiNiO₂, LiMn₂O₄ or a carbon-based active material, a ternary active material, a conductive agent, a binder, etc.

The negative electrode 113 includes a negative electrode current collector 113a and a negative active material layer 113b. The negative electrode current collector 113a has a plate shape, which is made of copper, stainless steel, aluminum, etc. The negative active material 113b is made of Li₄Ti₅O₁₂, the carbon-based active material, the conductive agent, the binder, or the like.

Referring to the bipolar electrodes 115, 115′, a first bipolar electrode 115 includes a bipolar current collector 115a and active material layers 115b and 115c, and a second bipolar electrode 115′ includes a bipolar current collector 115a′ and active material layers 115b′ and 115c′. The bipolar current collectors 115a, 115a′ are made of aluminum, stainless steel, a hetero junction metal of copper and aluminum, etc. First active material layers 115c, 115c′ made of a positive active material (e.g., lithium transition metal composite oxide) are respectively on one surface of the bipolar electrodes 115, 115′, and second active material layers 115b, 115b′ made of a negative active material(e.g., lithium transition metal composite oxide, graphite, carbon, or the like) are respectively on the other surface of the bipolar electrodes 115, 115′.

The separators 114 are made of a porous material. More specifically, the separators 114 may be made of Manila paper, polyethylene, polypropylene, or the like.

The first bipolar electrode 115 is between the positive electrode 112 and the negative electrode 113 and the second bipolar electrode 115′ is between an outer surface of the electrode assembly 110 and the positive electrode 112. The separators 114 are between the positive electrode 112, the negative electrode 113, and the bipolar electrodes 115, 115′. In addition, the separators 114 are on an outermost surface of the stacked electrode assembly 110.

In the described embodiment, the bipolar electrode 115′ is between an outer surface of the electrode assembly 110 and the positive electrode 112, but the present invention is not limited thereto. Therefore, the bipolar electrode 115′ may be between a center of the electrode assembly 110 and the negative electrode 113. As a result, the bipolar electrodes 115, 115′ are located alternately with the positive electrode 112 and the negative electrode 113.

The second active material layers 115b, 115b′ are formed on one surface of the bipolar electrodes 115, 115′, respectively, facing the positive electrode 112, and the first active material layers 115c, 115c′ are formed on the other surface of the bipolar electrodes 115, 115′, respectively, facing the negative electrode 113. As a result, charge and discharge may be efficiently performed through exchange of ions with the separators 114 therebetween.

Since two bipolar electrodes 115, 115′ are located alternately with the positive electrode 112 and the negative electrode 113, the electrode assembly 110 has a voltage two times higher than a conventional electrode assembly that does not have a bipolar electrode.

As such, two bipolar electrodes 115, 115′, one positive electrode 112, one negative electrode 113, and four separators 114 are required to obtain the voltage two times higher than the general electrode assembly. In another embodiment, four bipolar electrodes 115 are used in a rechargeable battery having a voltage three times higher than a conventional rechargeable battery.

That is, (N−1)×2 bipolar electrodes 115, 115′, one positive electrode 112, one negative electrode 113, and {(N−1)×2+1} separators 114 are required for a rechargeable battery having a voltage N times higher than the conventional rechargeable battery.

When the rechargeable battery has two bipolar electrodes 115, 115′ to generate twice as high voltage, the rechargeable battery has the same or substantially the same effect as two structures in which two unit cells coupled in series are coupled in parallel. For example, each of the first and second bipolar electrodes 115, 115′ includes two bipolar electrodes. A structure including such an electrode assembly wound in a cylindrical shape is referred to as a 2S2P structure.

When a rechargeable battery has four bipolar electrodes to generate three times as high voltage, the rechargeable battery has the same or substantially the same effect as two structures in which three unit cells coupled in series are coupled in parallel. A structure including such an electrode assembly wound in a cylindrical shape is referred to as a 3S2P structure.

Therefore, according to embodiments of the present invention, it is possible to control an output and a capacity of the rechargeable battery by adjusting the number of bipolar electrodes.

The positive electrode 112 includes a positive electrode coated region in which the positive active material 112b is formed and a positive electrode uncoated region 112c in which the positive active material 112b is not formed and the positive electrode current collector 112a is exposed. The negative electrode 113 also includes a negative electrode coated region in which the negative active material 113b is formed and a negative electrode uncoated region 113c in which the negative active material layer 113b is not formed and the negative electrode current collector 113a is exposed.

The electrode assembly 110 is first formed in an elongate stripe shape and thereafter is formed in the cylindrical shape by being wound by a mandrel.

In the electrode assembly 110 having the stripe shape, the positive electrode uncoated region 112c is positioned at one longitudinal end of the electrode assembly 110 and the negative electrode uncoated region 113c is positioned at the other longitudinal end of the electrode assembly 110. However, in another embodiment, the positive electrode uncoated region 112c and the negative electrode uncoated region 113c may be positioned at the same longitudinal end of the electrode assembly 110.

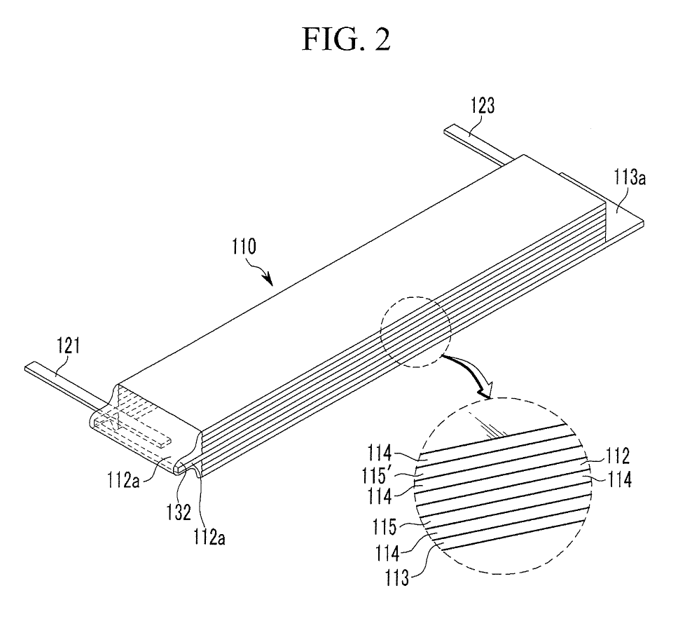

FIGS. 2 to 7 are schematic diagrams illustrating a process of manufacturing a rechargeable battery according to a first exemplary embodiment of the present invention.

Referring to FIGS. 2 to 7, first, as shown in FIG. 2, the bipolar electrode 115 is between the positive electrode 112 and the negative electrode 113 and of the second bipolar electrode 115′ is between an outer surface of the electrode assembly 110 and the positive electrode 112. Further, the separators 114 are between the positive electrode 112, the negative electrode 113, and the bipolar electrodes 115, 115′ and at the outer surface of the electrode assembly 110.

As described above, the positive electrode uncoated region 112c and the negative electrode uncoated region 113c are at opposite longitudinal ends of the electrode assembly 110, and the positive electrode lead unit 121 and the negative electrode lead unit 123 are bonded with the positive electrode uncoated region 112c and the negative electrode uncoated region 113c, respectively, by welding.

A front sealing unit 132 is formed by applying a sealing agent to a front part of the electrode assembly 110 to be wound (e.g., at an end positioned at an innermost portion of the electrode assembly 110). In the described embodiment, the front sealing unit 132 is wound on a portion of the electrode assembly 110 where the positive electrode uncoated region 112c is located near the front portion (e.g., the innermost portion of the electrode assembly 110) such that the front sealing unit 132 covers the positive electrode uncoated region 112c.

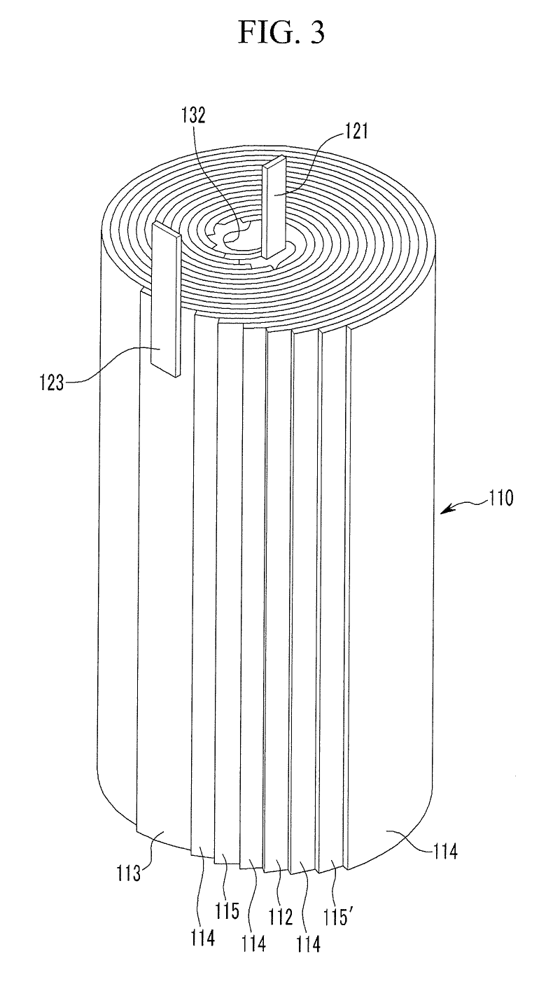

As shown in FIG. 3, the electrode assembly 110 is wound in the cylindrical shape, and the positive electrode lead unit 121 and the negative electrode lead unit 123 are facing outward from a top surface of the electrode assembly.

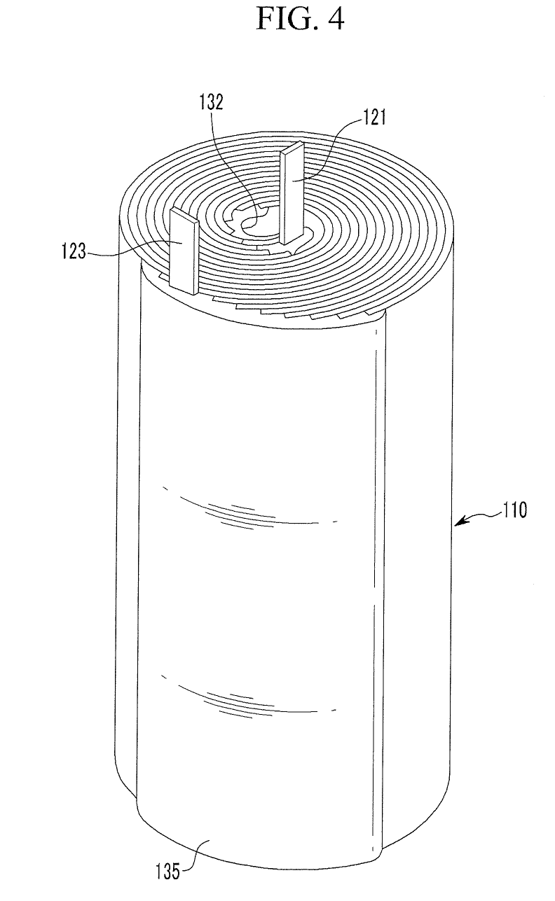

After the electrode assembly 110 is wound, a side sealing unit 135 is formed by applying the sealing agent onto a side of the electrode assembly 110 to cover ends of members constituting the electrode assembly 110 as shown in FIG. 4 (e.g., ends of the positive electrode 112, the negative electrode 113 and the first and second bipolar electrodes 115, 115′ that are located at or near the outer surface of the electrode assembly 110). The electrode assembly 110 may be fixed by being covered with a tape, etc., before the side sealing unit 135 is coupled to the side of the electrode assembly 110.

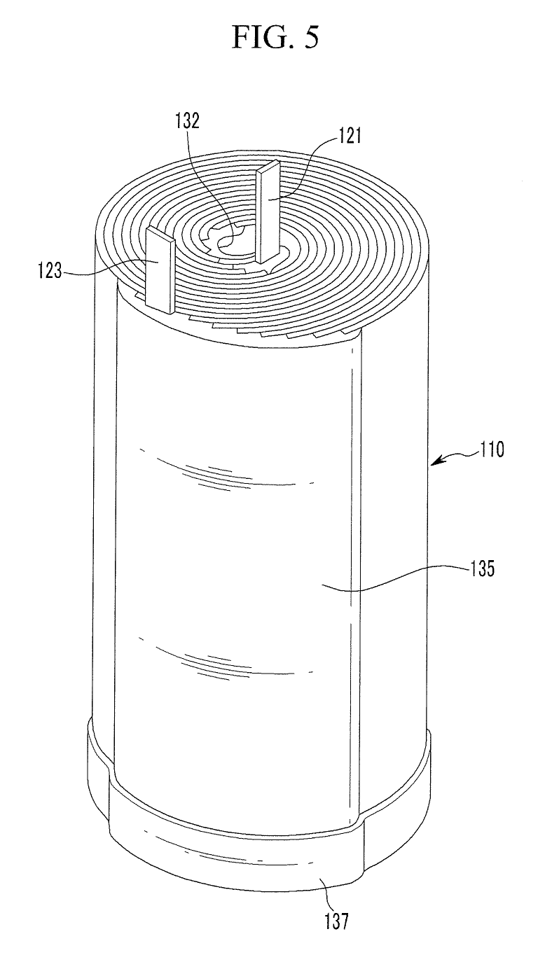

After the side sealing unit 135 is formed, a lower sealing unit 137 is formed by applying the sealing agent onto a lower end (e.g., a bottom end) of the electrode assembly 110 as shown in FIG. 5. The lower sealing unit 137 covers the entire lower end, of the electrode assembly 110.

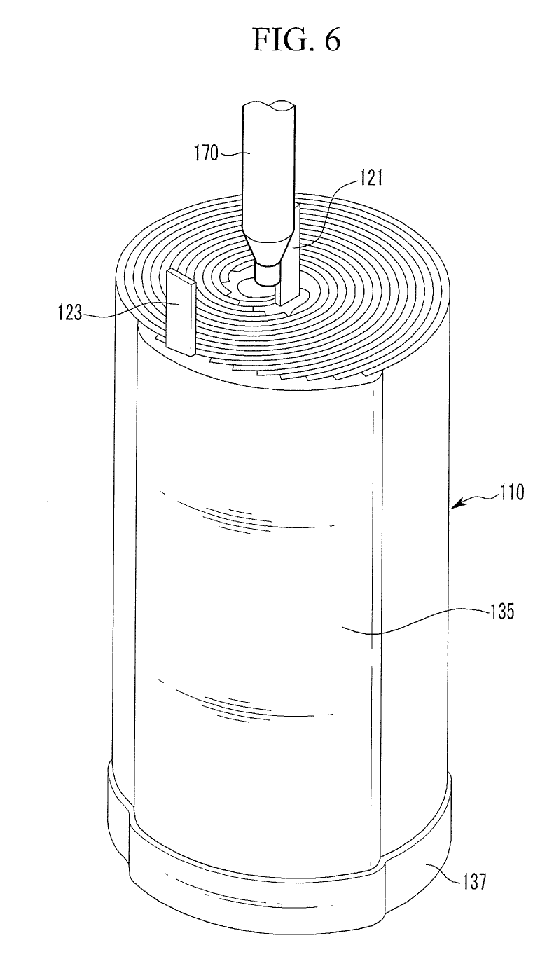

After the lower sealing unit 137 is formed, electrolytic solution is injected into the center of the electrode assembly 110 by using an electrolytic solution injector 170 as shown in FIG. 6. The side and the lower end of the electrode assembly 110 are sealed such that the electrolytic solution may be stably stored in the electrode assembly 110 without leaking.

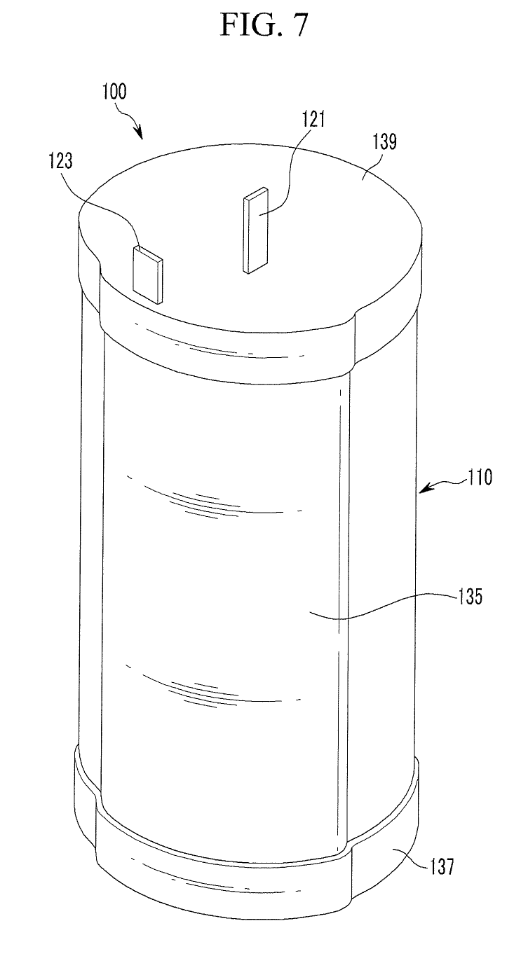

After injection of the electrolytic solution is completed, an upper sealing unit 139 is formed by applying the sealing agent onto an upper part (e.g., an upper end) of the electrode assembly 110 such that the rechargeable battery is configured as shown in FIG. 7. The upper sealing unit 139 covers an entire upper surface of the electrode assembly 110. The positive electrode lead unit 121 and the negative electrode lead unit 123 are facing outward from a top surface of the upper sealing unit 139. As a result, current may be drawn out to the outside of the electrode assembly 110 through the exposed positive electrode lead unit 121 and negative electrode lead unit 123.

In the described embodiment, polyimide-based resins, polyethylene resins, polypropylene resins, etc., that interact with the electrolytic solution, may be utilized as the sealing agent. Various kinds of sealing agents may be utilized depending on the type of electrolytic solution.

In accordance with the described embodiment, the first bipolar electrode 115 between the positive electrode 112 and the negative electrode 113 and the second bipolar electrode 115′ between an outer surface of the electrode assembly 110 and the positive electrode 112 are provided so as to more easily manufacture the rechargeable battery having the voltage N times higher than a conventional rechargeable battery. Further, it is possible to increase the voltage without remarkably increasing the volume of the battery by using the bipolar electrodes 115, 115′. Therefore, the output of the rechargeable battery is increased.

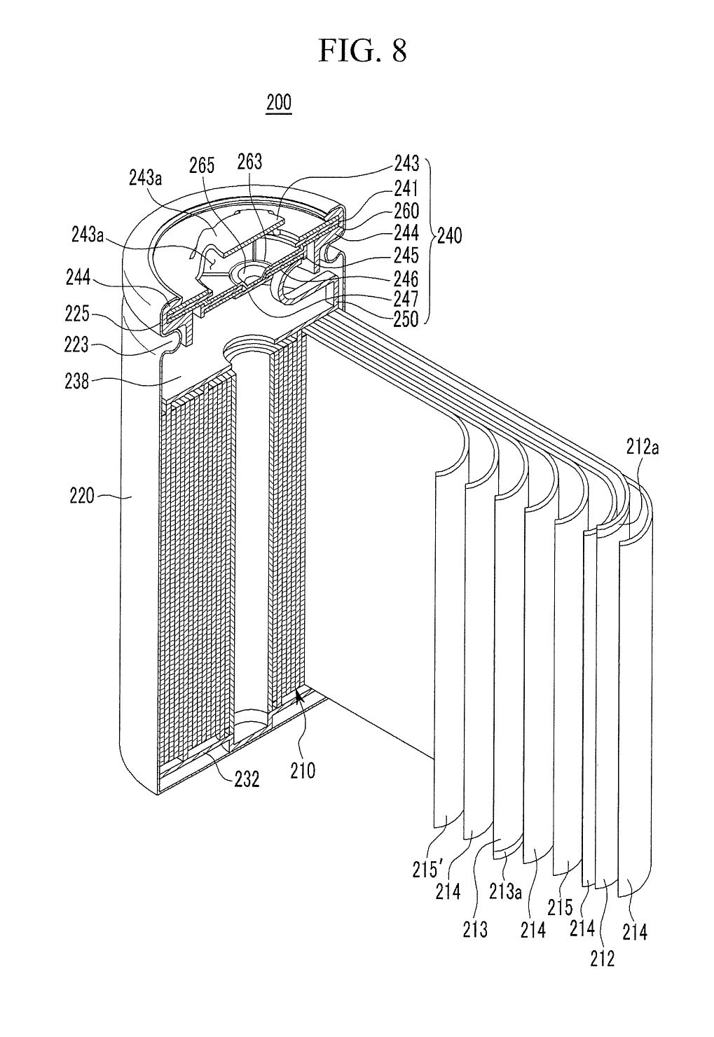

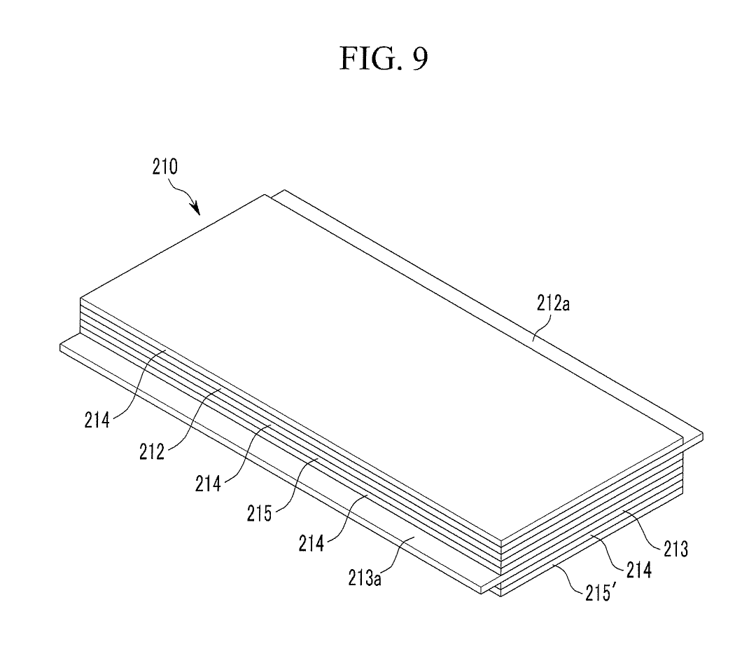

FIG. 8 is a cross-sectional perspective schematic diagram of a rechargeable battery according to a second exemplary embodiment of the present invention. FIG. 9 is a cross-sectional perspective schematic diagram of an electrode assembly according to a second exemplary embodiment of the present invention.

Referring to FIGS. 8 and 9, an electrode assembly 210 of the rechargeable battery 200 according to the described embodiment of the present invention includes a positive electrode 212, a negative electrode 213, and bipolar electrodes 215, 215′ that are stacked together.

The first bipolar electrode 215 is between the positive electrode 212 and the negative electrode 213 and the second bipolar electrode 215′ is between a center of the electrode assembly 210 and the negative electrode 213. Separators 214 are between the positive electrode 212, the negative electrode 213, and the bipolar electrodes 215, 215′, and coupled with the positive electrode 212, the negative electrode 213, and the bipolar electrodes 215, 215′. As a result, the bipolar electrodes 215, 215′ are located alternately with the positive electrode 212 and the negative electrode 213.

The positive electrode 212 has a positive electrode uncoated region 212a in which an active material is not applied and the negative electrode 213 has a negative electrode uncoated region 213a in which the active material is not applied. The positive electrode uncoated region 212a is on a stripe-shaped elongate side surface extending from the top end of the electrode assembly 210 and the negative electrode uncoated region 213a is on a stripe-shaped elongate side surface extending from the bottom end of the electrode assembly 210.

The electrode assembly 210 is contained in a case 220 in its wound configuration. The rechargeable battery 200 includes the electrode assembly 210, the case 220 having an opening on one end to receive electrolytic solution. A cap assembly 240 sealing the case 220 is installed in the opening of the case 220 via a gasket 244.

Sealing units may be formed on an innermost portion, a side, an upper end, and a lower end of the electrode assembly 210.

More specifically, the case 220 is made of conductive metal such as aluminum, aluminum alloy, or nickel-plated steel.

Further, the case 220 according to the described embodiment has a cylindrical shape having an inner space for receiving the electrode assembly 210. The cap assembly 240 is fixed by clamping after being fitted in the case 220. In this process, a beading portion 223 and a clamping portion 225 are formed in the case 220.

Although the electrode assembly 210 according to the exemplary embodiment has a cylindrical shape which is wound in an eddy current shape, the electrode assembly 210 is not limited thereto, but may have other shapes.

In the wound cylinder configuration, the positive electrode uncoated region 212a is at an upper end (e.g., the top end) of the electrode assembly 210, such that the positive electrode uncoated region 212a is electrically connected with a positive electrode current collecting plate 238. Further, a negative electrode uncoated 213a in which a negative active material is not applied is formed at a lower end (e.g. the bottom end) of the negative electrode 213, such that the negative electrode uncoated region 213a is electrically connected with a negative electrode current collecting plate 232.

The negative electrode 213 includes a current collector made of copper or aluminum to which a negative active material is applied. The positive electrode 212 includes a current collector made of aluminum to which a positive active material is applied.

The negative active material may include a carbon-based active material and the positive active material may include the carbon-based material, a manganese-based active material, or a ternary active material.

The cap assembly 240 includes a cap-up 243 including a protruding outer terminal 243a and an exhaust hole 243b, and a vent plate 260, which is installed below the cap-up 243 and includes a notch 263 that is configured to break at a predetermined pressure condition to discharge gas. The vent plate 260 breaks the electrical connection between the electrode assembly 210 and the cap-up 243 at the predetermined pressure condition.

A positive temperature coefficient element 241 is installed between the cap-up 243 and the vent plate 242. The positive temperature coefficient element 241, which provides approximately infinite electrical resistance when the temperature exceeds a threshold, intercepts charge or discharge current when the temperature of the rechargeable battery 200 exceeds a threshold temperature.

A convex portion 265 protrudes downward at a center of the vent plate 260. A sub-plate 247 is coupled to the bottom of the convex portion 265 by welding.

A cap-down 246 is between the vent plate 260 and the sub-plate 247. The cap-down 246 has a disc shape and includes a hole for receiving the convex portion 265 at the center thereof.

An insulating member 245 is between the cap-down 246 and the vent plate 260 to insulate the cap-down 246 and the vent plate 260 from each other.

Therefore, the convex portion 265 of the vent plate 260 may be easily bonded with the sub-plate 247 through the holes.

The sub-plate 247 is welded to the convex portion 265 and the cap-down 246. The cap-down 246 is electrically connected with the electrode assembly 210 through a lead member 250. Through this structure, current may be easily transmitted to the vent plate 260 and the vent plate 260 transmits (e.g., directs) the current to the outer terminal 243a of the cap-up 243 by being bonded with the cap-up 243.

Further, when an internal pressure of the rechargeable battery 200 increases, the convex portion 265 is separated from the sub-plate 247 to intercept the current.

When the electrode assembly 210 having the bipolar electrodes 215, 215′ is inserted into the case 220 of the rechargeable battery 200, a rechargeable battery 200 having voltage N times higher than the conventional battery may be easily provided.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode assembly comprising:
a positive electrode comprising a positive electrode current collector and a positive active material layer;
a negative electrode comprising a negative electrode current collector and a negative active material layer;
a first bipolar electrode between the positive electrode and the negative electrode; and
a second bipolar electrode between an outer surface of the electrode assembly and the positive electrode or between a center of the electrode assembly and the negative electrode; and
separators between the positive electrode, the negative electrode, and the first and second bipolar electrodes.

2. The electrode assembly of claim 1, wherein each of the first and second bipolar electrodes comprises:
a current collector;
a first active material layer on one surface of the current collector and comprising a positive active material; and
a second active material layer on the other surface of the current collector and comprising a negative active material.

3. The electrode assembly of claim 2, wherein the first active material layer comprises lithium transition metal composite oxide and the second active material layer comprises a material selected from the group consisting of lithium transition metal composite oxide, graphite, carbon, and combinations thereof.

4. The electrode assembly of claim 1, further comprising:each of the first and second bipolar electrodes comprises two bipolar electrodes.

5. The electrode assembly of claim 1, wherein the positive electrode comprises a positive electrode uncoated region and a positive electrode coated region, the positive electrode coated region including the positive active material layer,the negative electrode comprises a negative electrode uncoated region and a negative electrode coated region, the negative electrode coated region including the negative active material layer, and the positive electrode uncoated region is located at one longitudinal end of the electrode assembly and the negative electrode uncoated region is located at the other longitudinal end of the electrode assembly.

6. The electrode assembly of claim 1, wherein:
the positive electrode, the negative electrode, and the first and second bipolar electrodes are stacked and wound in a cylindrical shape.

7. A rechargeable battery comprising:
an electrode assembly comprising a positive electrode, a negative electrode, and a first bipolar electrode between the negative electrode and the positive electrode and a second bipolar electrode between an outer surface of the electrode assembly and the positive electrode or between a center of the electrode assembly and the negative electrode, wherein the positive electrode, the negative electrode, and the bipolar electrodes are stacked and wound together; and
a lead electrically coupled with the electrode assembly.

8. The rechargeable battery of claim 7, further comprising:
separators between the positive electrode, the negative electrode, and the first and second bipolar electrodes.

9. The rechargeable battery of claim 7, wherein each of the first and second bipolar electrodes comprises:
a current collector;
a first active material layer on one surface of the current collector and comprising a positive active material; and
a second active material layer on the other surface of the current collector and comprising a negative active material.

10. The rechargeable battery of claim 7, further comprising: each of the first and second bipolar electrodes comprises two bipolar electrodes.

11. The rechargeable battery of claim 7, wherein
the positive electrode comprises a positive electrode uncoated region and a positive electrode coated region including the positive active material layer,
the negative electrode comprises a negative electrode uncoated region and a negative electrode coated region including the negative active material layer, and
the positive electrode uncoated region is located at one longitudinal end of the electrode assembly and the negative electrode uncoated region is located at the other longitudinal end of the electrode assembly.

12. The rechargeable battery of claim 7, further comprising:
a front sealing unit formed by applying a sealing agent at an end positioned at an innermost portion of the electrode assembly.

13. The rechargeable battery of claim 7, further comprising:
a side sealing unit formed by applying a sealing agent at ends of the positive electrode, the negative electrode, and the first and second bipolar electrodes that are located at or near the outer surface of the electrode assembly.

14. The rechargeable battery of claim 7, further comprising:
a lower sealing unit formed by applying a sealing agent on a bottom end of the electrode assembly utilizing a sealing agent.

15. The rechargeable battery of claim 7, wherein:
an upper sealing unit formed by applying a sealing agent on an upper end of the electrode assembly.

16. The rechargeable battery of claim 12, wherein:
the sealing agent comprises a material selected from the group consisting of polyimide-based resins, polyethylene resins, polypropylene resins, and combinations thereof.

17. The rechargeable battery of claim 7, further comprising:
a case containing the electrode assembly; and
a cap assembly coupled with the case and electrically coupled with the electrode assembly.
